(19) United States
(12) Patent Application Publication
(10) Pub. No.: US 2015/0334077 A1
(43) Pub. Date: Nov. 19, 2015

(54) MAP-BASED REMARKS

(71) Applicant: Douglas E. Feldman, Los Angeles, CA (US)

(72) Inventor: Douglas E. Feldman, Los Angeles, CA (US)

(21) Appl. No.: 14/715,509

(22) Filed: May 18, 2015

Related U.S. Application Data
(60) Provisional application No. 61/994,591, filed on May 16, 2014.

(51) Int. Cl. H04L 12/58; G06F 3/0481; G06F 3/0484

(52) U.S. Cl. CPC H04L 51/32; G06F 3/04842; G06F 3/04817; G06Q 50/01

(57) ABSTRACT

A method for sharing a geopost includes controlling a shared map image post via a sharing application, capable of sharing a post on a social network, wherein the sharing application comprises a map with a GPS location capable of being authenticated by at least two authentication inputs, providing a prebuilt application protocol which sends the at least two authentication inputs to the third party social network, authorizing a third party social network with a posting permission, where the posting is both shared and sharable, and the sharing application is stored on a non-transitory computer-readable medium, superimposing a semitransparent circle on a map in the user interface, around the GPS location, providing a search input filed and a search function, and providing a hidden posting function capable of publishing to the third party social network only upon touching a portion of the map via the user interface in the mobile software application.

### CROSS-REFERENCE TO RELATED APPLICATIONS

This application is a non-provisional of provisional app. Ser. No. 61/994,591 to Feldman filed on May 16, 2014 in the U.S. Patent & Trademark Office.

### BACKGROUND OF THE INVENTION

1. Field of Invention

The present invention relates to maps and publishing tools, including the creation and sharing of geographically associated remarks to third party systems.

2. Description of the Related Art

The scope of the related art concerns simple social media sharing which is significantly limited by the number of characters and therefore the complexity of a given posting. Some social networks systems such as Twitter limit characters to 140 characters and a single image. Other social networks, such as Instagram.com, permit filters of pre-created works, though not geared toward maps. However, such social networks generally do not provide substantial visual editing interfaces to significantly modify a map image, let alone how a map is tagged and displayed to users.

Some examples in the related art include: U.S. Pat. App. Pub. Nos. 20140101250; 20140101246; 20140089422; 20140040374; 20140067937; 20140012927; 20140012909; 20140006129; 20140089343; 20130325977; 20130325975; 20130325964; 20130311452; 20130297688; 20130275222; 20130268594; 20130268357; 20130252594; 20130227061; 20130225198; 20130210395; 20130196690; 20130179523; 20130166661; 20130166465; 20130166385; 20130138741; 20130132489; 20130124633; 20130097162; 20130073474; 20130073388; 20130073377; 20130073336; 20130040654; 20130036165; 20130013693; 20130013595; 20130012239; 20130007864; 20120324018; 20120296987; 20120284112; 20120239479; 20120233158; 20120197724; 20120191543; 20120190387; 20120166433; 20120166432; 20120166284; 20120158845; 20120136900; 20120109752; 20120089451; 20120047129; 20110310120; 20110282972; 20110276398; 20110252095; 20110159890; 20110153553; 20110138006; 20110137997; 20110137996; 20110137814; 20110125693; 20110125692; 20110125690; 20110125689; 20110083101; 20110072071; 20100325127; 20100313142; 20100283676; 20100076951; 20100036912; 20100011081; 20090235176; 20090215469; 20090198645; 20090054043; 20080301112; 20080104227; 20080102856; 20080086261; 20070271367; 20070268864; 20070037574; 20060270419; 20060085419; 20060047825; 20110039623; 20110039622; 20130013397; 20130110631; 20130238658; 20120270563; 20110238762; 20080250337; 20070249368; U.S. Pat. Nos. 8,527,597; 8,312,380; 8,108,144; 6,654,800; and China (CN) App. Ser. No. CN102760129A. However, such related art fails to teach or fairly suggest a streamlined publishing system which is easy to use through reduced steps leading to sharing of a map via a sharing application capable of posting to a third party social network. For example, in the case of Ding, et al., its teachings add comment information of geographical positions on a network map, improving the credibility of comment information, thus enabling comment information provided from the network map to have larger reference values. However, merely providing geographical position on a network map to enhance credibility of comments fails to provide searchability of a conventional geographically-oriented post in a desired searchable area as specified by the posting comment. Furthermore, limiting to social media sharing, particularly when limited to a specific social media network, is not conducive to widespread dissemination of information targeted to the designated post area.

Further, conventional approaches to simple social media sharing of map locations and content associated with maps were unable to permit rapid selection and sharing of a geographically tagged location and are typically tied to the mobile user's location, based on their GPS location. Conventional geolocation-embedded posting with the phone's GPS location is known in the related art. Such conventional posting is often in metadata, whether in an image, video, or in association with text. For example, conventional social networks such as Twitter do not currently permit specifying a radius beyond one's location as a criterion or metadata at the same time the content is shared. In addition, searching content by precise location within a radius using social media tools such as Twitter is highly limited. For example, on Twitter, it is not possible to search for “hamburger” within two kilometers of a specified location. Although some social networks may specify a radius based on a city name, for example, such boundaries are not adjusted just prior to sharing a post in social media.

Social mobile applications are also known in the related art. Some known social networks include: 43 Things, Academia.edu, About.me, Advogato, allobii, AsianAvenue, aSmallWorld, Athlinks, Audimated.com, Bebo, Biip.no, BlackPlanet, Blauk, Blogster, Bolt.com, Busuu, Buzznet, CafeMom, Caret, CaringBridge, Classmates.com, Cloob, CouchSurfing, CozyCot, Cross.tv, Crunchyroll, Cyworld, DailyBooth, DailyStrength, delicious, deviantART, Diaspora, didlr, Disaboom, Dol2day, DontStayln, Draugiem.lv, douban, DXY.cn, Elftown, Elixio, English, baby!, Epernicus, Eons.com, eToro, Experience Project, Exploroo, Facebook, Faceparty, Faces.com, Fetlife, FilmAffinity, Filmow, FledgeWing, Flixster, Flickr, Focus.com, Formspring, Fotki, Fotolog, Foursquare, Friendica, Friends Reunited, Friendster, Frühstückstreff, Fuelmyblog, FullCircle, Gaia Online, GamerDNA, Gapyear.com, Gather.com, Gays.com, Geni.com, GetGlue, Gogoyoko, Goodreads, Goodwizz, Google+, GovLoop, Grono.net, Habbo, hi5, Hospitality Club, Hotlist, HR.com, Hub Culture, Hyves, Ibibo, Identi.ca, Indaba Music, Instagram, IRC-Galleria, italki.com, Itsmy, iWiW, Jaiku, Jiep ng, Kaixin001, Kiwibox, Lafango, LaiBhaari, Last.fm, LibraryThing, Lifeknot, LinkedIn, LinkExpats, Listography, LiveJournal, Livemocha, Makeoutclub, MEETin, Meetup, Meettheboss, MillatFacebook, mixi, MocoSpace, MOG, MouthShut.com, Mubi, MyHeritage, MyLife, My Opera, Myspace, Nasza-klasa.pl, Netlog, Nexopia, NGO Post, Ning, Odnoklassniki, Open Diary, Orkut, OUTeverywhere, PatientsLikeMe, Partyflock, Pingsta, Pinterest, Plaxo, Playfire, Playlist.com, Plurk, Poolwo, Qapacity, Quechup, Qzone, Raptr, Ravelry, Renren, ReverbNation.com, Ryze, ScienceStage, Sgrouples, ShareTheMusic, Shelfari, Sina Weibo, Skoob, Skyrock, SocialVibe, Sonico.com, SoundCloud, Spaces, Stage 32, Stickam, StudiVZ, Students Circle Network, StumbleUpon, Tagged, Talkbiznow, Taltopia, Taringa!, TeachStreet, TermWiki, The Sphere, TravBuddy.com, Travellerspoint, tribe.net, Trombi.com, Tuenti, Tumblr, Twitter, Tylted, Vkontakte, Vampirefreaks.com, Viadeo, Virb, Vox, Wattpad, WAYN, WeeWorld, We Heart It, Wellwer, WeOurFamily, Wepolls.com, Wer-kennt-wen, weRead, Wiser.org, Wooxie, WriteAPrisoner.com, Xanga, XING, Xt3, Yammer, Yelp, Zoo.gr, Zooppa, etc. Conventional social media apps do not simultaneously provide both geosearch and geopublish map-displays.

Map-based tools, like Waze, do not by default create independently shared maps designed to be sharable with third party social networks. Such systems do not facilitate rapid creation and sharing of map-based social posts that are also searchable as one of a few prominent, simple functions within the same app. Waze is a mobile app which permits posting of a road condition selectable from a list, with a visual depiction on a map, relating to the user's GPS position or closely associated therewith associated with a passenger's driving path. However, Waze is not designed to easily designate an expandable or retractable radius included in a post to third party social networks.

A disadvantage of short-post social networks and applications is the failure to provide simple, easy to use creation tools for map-related posts, and further to dynamically generate such maps associated with posts quickly and easily without numerous user interface options. Such social networks do not easily create marked sharable images of geotagged maps in social media. Moreover, conventional text-based posts lack GPS information, and such text-based posts generally do not indicate one's present geolocation nor a desired geolocation about a third party location. Furthermore, conventional posts even with a location associated thereto may not provide geopost-searchable functions within a specific radius along with such rapid map sharing.

In addition, conventional web-based map systems such as Google Maps, Yahoo! Maps, and MapQuest conventionally require an address or other information and do not provide posting capabilities via social networks as a regular or primary function. Manual GPS location inputs, or manually inputting a radius around a pinpoint on the map—two distinct steps—can be time-consuming and may deter prospective posting of map-related posts in social networks. Complete publication processes can result in user fatigue, distraction, interruption, or any other reason that severs that completion to full publishing. Requiring multiple steps increases the difficulty for a user to complete a multi-step process to obtain a desired search or post with simultaneous parameters of one or more keywords (e.g. “burger”), within a specified area or radius (e.g., “5 miles”), and social network (e.g., “Twitter”).

Therefore, it can be seen that there is a need for a system that provides fewer steps to create and share geographically relevant posts in social media. Furthermore, it can be seen that an easy-to-use geographic search and social search tool is needed. Furthermore, it can be seen that there is a need for a simplified social geo-tagging creation system and method for quickly and easily sharing an image of a map with a comment associated with an address or location searchable by the combination of a keyword and radius. In accordance with the present invention, an easy to use, social media friendly, sharable geotagging system and method is provided that can eliminate or reduce one or more of the disadvantages and problems described herein. Accordingly, the present invention satisfies these and other needs using a control mechanism having a user interface to activate geosearching and geopublishing functions described herein.

### SUMMARY OF THE INVENTION

Briefly, and in general terms, the present invention is directed to a map-related remark system with social geographic search and sharing. An aspect of the invention can be to search a social network via a mobile device application to search content of social posts within a specified area on a map. In another aspect, the present invention can provide streamlined publishing with simple steps to create a visually useful map of an event location in association with geographic remarks posted to a social network and having location information associated therewith. In a further aspect, the invention can provide easy-to-use posting capability.

The present invention provides an easy-to-use, rapid searching and/or publishing without requiring excessive manual input, or extraneous steps, inputs, or uploads.

The present invention may be configured for use with a GPS-enabled device or a non-GPS-enabled device. Locations and posts can be simultaneously searched regardless of current location based on geoposted content within a radius specified by the user.

An aspect of the present invention can be to streamline the creation and dissemination of a geopost along with an automatically generated, yet customized, map image.

Other features and advantages of the invention will become apparent from the following detailed description, taken in conjunction with the accompanying drawings, which illustrate, by way of example, the features of the invention.

### BRIEF DESCRIPTION OF THE DRAWINGS

FIG. 1 (Prior Art) is an example of the related art providing a text-based search function in a social network.

FIG. 2 (Prior Art) is an example of the related art requiring manual input to establish a radius on a map.

FIG. 3A (Prior Art) is an example of certain components known in the related art.

FIG. 3B s a user interface of an embodiment of the present invention.

FIG. 3C is a user interface of an embodiment of the present invention.

FIG. 3D is a user interface of an embodiment of the present invention.

FIG. 3E is a user interface of an embodiment of the present invention.

FIG. 4 is a user interface of an embodiment of the present invention.

FIG. 5 is a user interface of an embodiment of the present invention.

FIG. 6 is a user interface of an embodiment of the present invention.

FIG. 7 is a user interface of an embodiment of the present invention.

FIG. 8 is a searching method of an embodiment of the present invention.

FIG. 9 is a publishing method of an embodiment of the present invention.

### DETAILED DESCRIPTIONS OF THE PREFERRED EMBODIMENTS OF THE INVENTION

As used herein, the following terms are defined as follows:

The term “geopost” can refer to posting of information or metadata, including but not limited to any of the following: location, area, region, map, coordinates, position, or any combination thereof, relative or absolute, now known or future developed.

The term “geosearch” can refer to searching of information or metadata, including but not limited to any of the following: location, area, region, map, coordinates, position, or any combination thereof, relative or absolute, now known or future developed.

The term “geotag” can refer to the inclusion of geographical information along with any other information or metadata, including but not limited to any of the following: location, area, region, map, coordinates, position, or any combination thereof, relative or absolute, now known or future developed.

The term “select-and-drag” can refer to touch-and-drag on a touchscreen, click-and-drag on a mouse or pointer device, or similar gesture control, now known or developed in the future.

The term “data” can refer to a collection of bits and bytes that are not human-readable.

The term “information” can refer to any or all of the numeric references set forth in this specification, including user interface widgets which provide information in the form of a shape, symbol, or other form of information.

Furthermore, what is regarded as the invention are not data per se, but rather, information that is useful and as a whole or in part.

As shown in the drawings for purposes of illustration, disclosed is a method for easy posting of geotagged maps by providing a third party social network authorization to a map interface via a GPS location capable of being authenticated by at least two authentication inputs, providing a prebuilt application protocol which sends the at least two authentication inputs to the third party social network, authorizing a third party social media website with a posting permission, where the posting is both shared and sharable, superimposing a semitransparent circle in the map interface; around the GPS location, providing a search input field and a search function, and providing a hidden or revealed posting function capable of publishing to the third party social network only upon touching a portion of the map via the user interface.

Turning now to the drawings, in which like reference numerals represent like or corresponding aspects of the drawings:

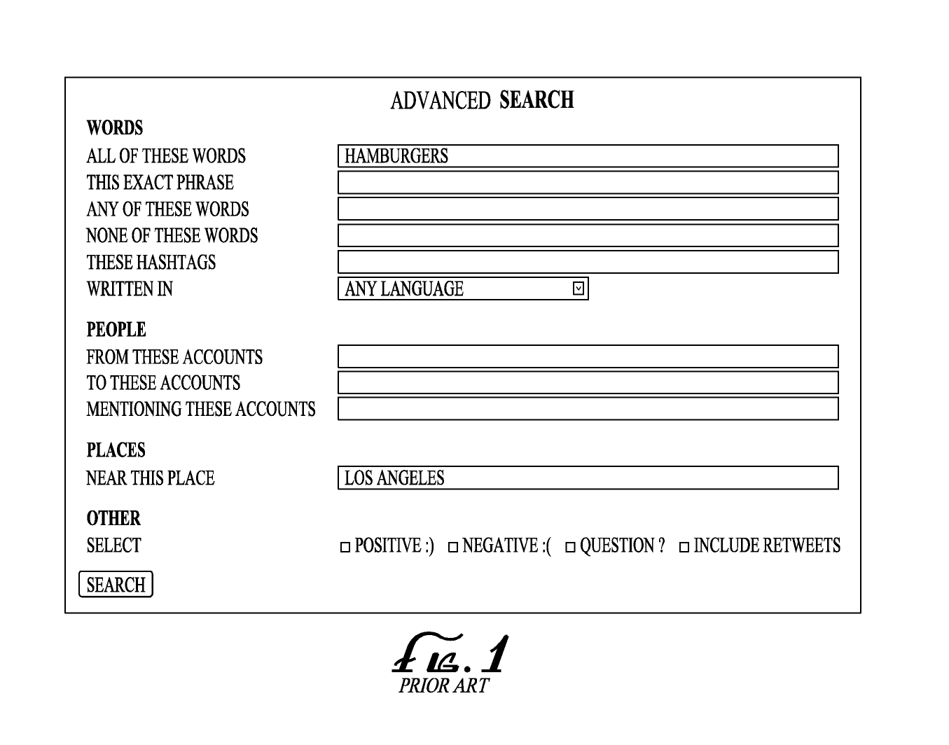

FIG. 1 (Prior Art) is an example of the related art providing a text-based search function in a social network. Test-based search field 100 is shown in FIG. 1. Test-based search field 100 is known. Search button 102 is known.

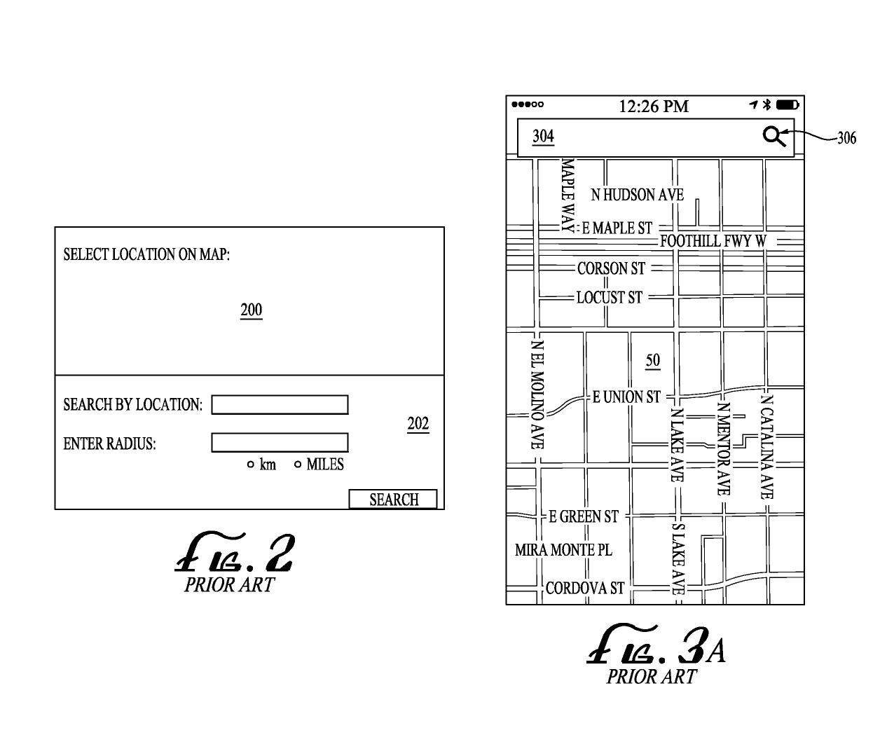

FIG. 2 (Prior Art) is an example of the related art requiring manual input to establish a radius on a map. Forming a circle on the map in the known manner of numeric input requires cumbersome data entry, lacks social network integration, and further lacks rapid steps to streamline social map sharing. Map 200 is known in the related art. Map 200 can permit selectable locations to designate a specific location on the map. Such map 200 is known conventionally to be displayed for reference or navigation guidance purposes on a GPS device, tablet, phone, desktop computer, or other computing device. Absence of keyword radius search 202 is shown with map 200. The related art as shown in FIG. 2 indicates an absence of both keyword 322 and an absence of search area 305. No social network identifier 506 is integrated therein. No geoposting command 510 associated with any social network or social network identifier 506 is provided therein.

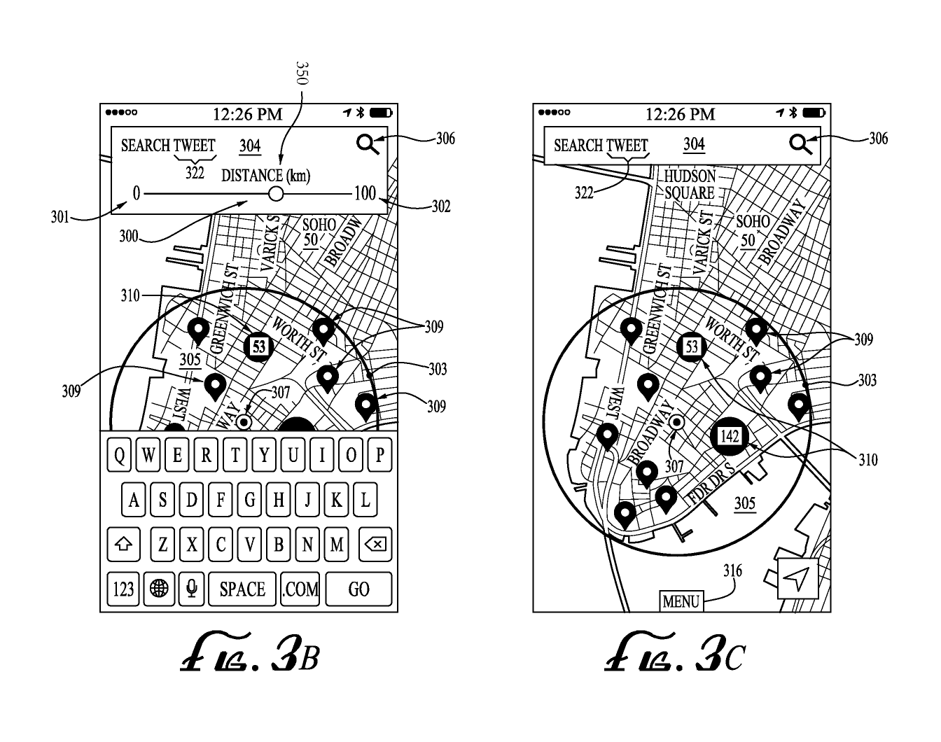

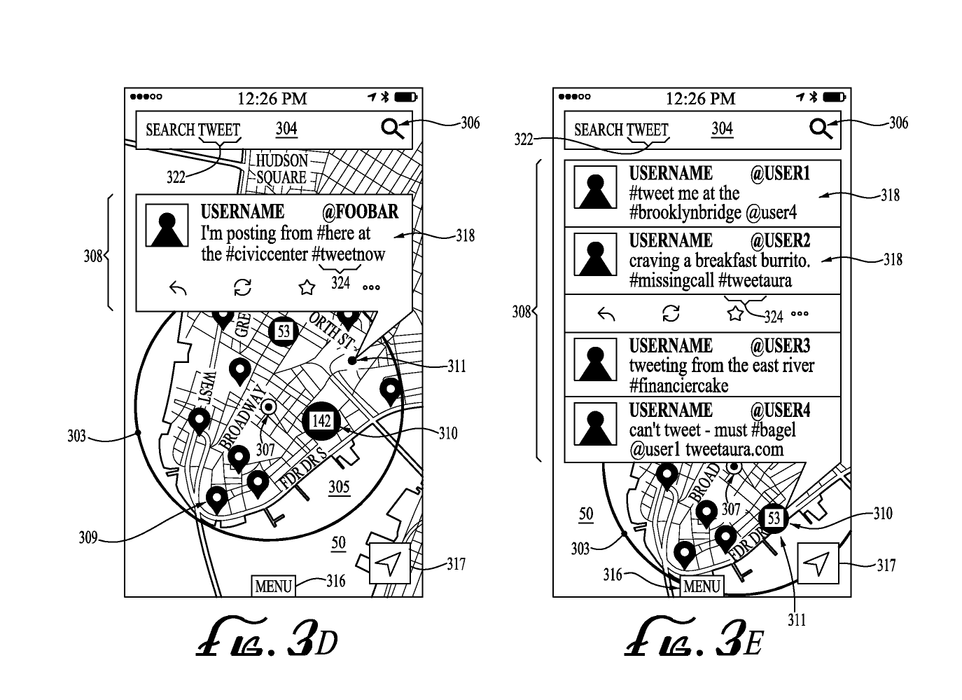

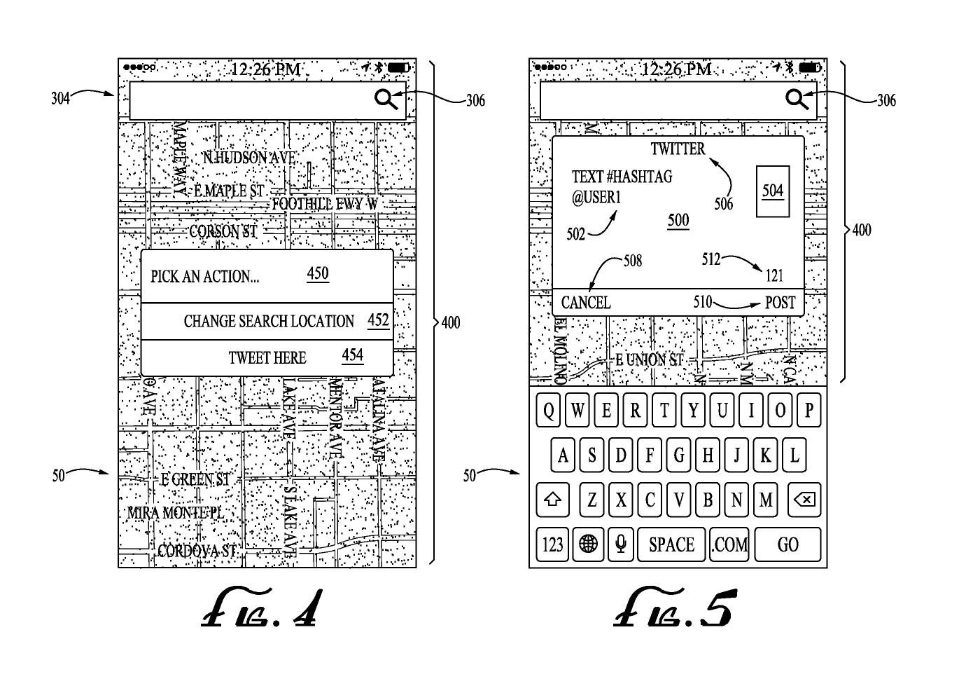

FIG. 3A (Prior Art) is an example of certain components known in the related art. Map 50 is shown with search input field 304 and search command 306.

Generally, map interface or user interface can be provided as shown overall in FIGS. 3B-3E and 4-7. One having an ordinary level of skill in the pertinent art would know how to incorporate the map interface or user interface with the present invention based on the present disclosure.

FIG. 3B is a user interface of an embodiment of the present invention. In a preferred embodiment, the present invention can be controlled via a client application on a mobile computing device. The following components can preferably be implemented using a mobile device client communicating to a server or cloud.

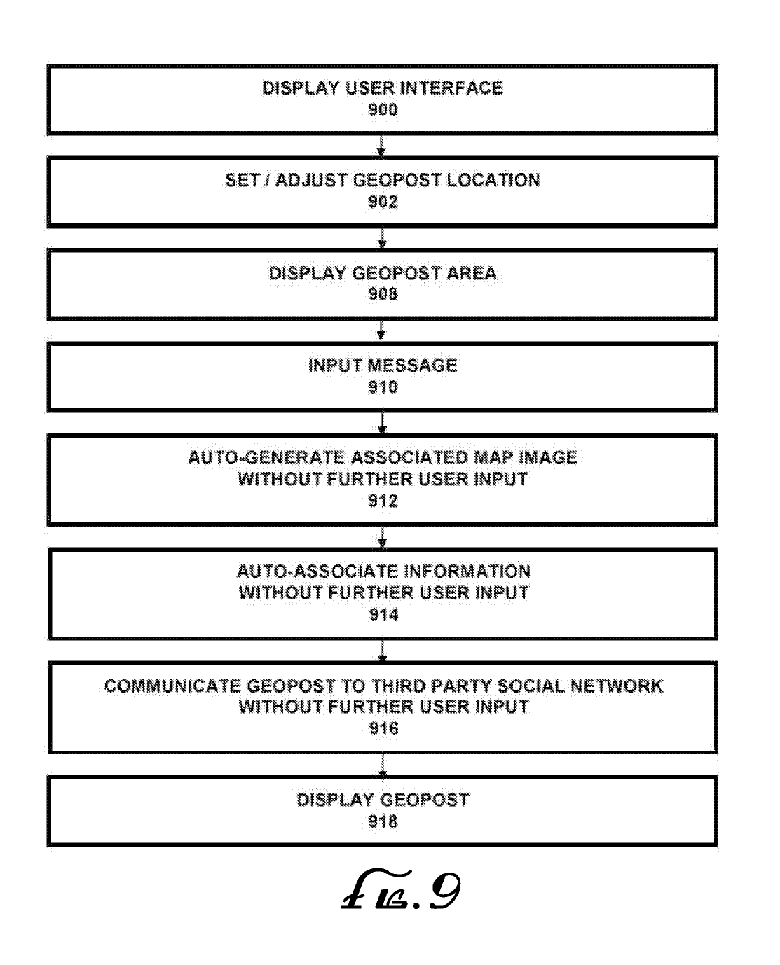

Map 50 is shown in FIG. 3B, with slider 300; slider 300 can be adjustable between minimum size 301 and maximum size 302 and can control the relative size of perimeter 303 to cover area 305. Slider 300 can aid in controlling, for example, by specifying search area 305 or perimeter 303. Slider 300 can limit discoverable geopost information. By way of non-limiting illustration, geolocations of posts 309 and 310 can be discoverable by performing search 800-810 (FIG. 8). Slider 303 can adjust the perimeter 303. Slider 303 can be directly below search input field 304. Search area 305 can be formed within perimeter 303.

Minimum size 301 and maximum size 302 can each be a number or an indication of relative size, by way of non-limiting illustration: a plurality of bars, circles, gradient, or numbers from minimum 301 to maximum 302.

Perimeter 303 can be an outline of an area on a map 200. By way of non-limiting illustration, perimeter 303 can be an outline of any shape, including without limitation any of the following: circle, ellipse, rectangle, polygon, or other shape.

Search input field 304 can permit entry of text input which can be sent to a server which can return results. In a preferred embodiment, search input field 304 can be rectangular, positioned near the top of the mobile device screen or user interface, juxtaposed on map 50, and adjacent to search command 306. In a preferred embodiment, there can be local input provided using a native operating system, for example, including but not limited to: Windows Mobile, Windows 8, Android, iOS, or any proprietary operating system, can provide for input capability of characters, sounds as characters, symbols as characters, spoken words or phrases as characters, shortcuts as characters, and the like. Input into search input field 304 can also be performed by any other input technique provided by an operating system, software or hardware, now known or developed in the future.

Area 305 can be a searchable area (FIG. 3B, 3C, 3D, 3E) or findable area associated with a given designated geolocation 307. A portion of map 50 can be viewable within area 305. Area 305 can limit the interactive area by which posts can be discovered within the perimeter 303. A benefit of area 305 can be to designate, at the time of geopublishing, the boundaries of which a given post can be found by another. A geosearch area 305 can designate the searchable area of any search keyword 322 entered upon geosearching, or the discoverable area of a given discoverable keyword 324.

Search command 306 can be activated to send a query to a server with the input from search input field 304. Search command 306 can be indicated by a search icon, search button, symbol, word, action, or by typing a character input thereby activating an automated search upon received one or more characters in the search input field 304. By way of non-limiting illustration, search command 306 can be activated by selecting a magnifying glass. In an embodiment, search command 306 can be automatically executed without requiring typing. The mere presence of a visual representation of search command 306 can be sufficient to indicate activating or initiating search command 306. Slower networks in geographies running slower preferably do not excessively submit queries on premature input, by way of non-limiting illustration, less than 2 to 5 characters. Search commands can be sent to a local server near the physical location with cached information of geographic information to enhance server responsiveness and to avoid network congestion over many nodes, preferably via local servers having fewer points of potential disruption to the client mobile device.

Designated geolocation 307 can be a map marker on map 50. Designated geolocation 307 can be within or centered upon perimeter 303. Designated geolocation 307 having a map marker can be, by way of non-limiting illustration, a dot, pixel, rectangle, circle, pin, or other shape. Designated geolocation 307 can be can have area 305 associated therewith. An aspect of designated geolocation 307 can be to facilitate geolocation keyword searching upon activating search command 306 via search icon. A geolocation keyword search can be based on designated geolocation 307 and keyword search input 322 found in geopost 318 with searched keyword 324.

Geopost list 308 can be shown as one or more geopost. In a preferred embodiment, the location can be associated at location of interest 311. Plurality of geoposts 318 in list 308 can be shown by displaying certain content in list 308, including, by way of non-limiting illustration, re-sharing, an indicator of location for multiple geoposts. Viewing list 308 can also entail further interaction with selected geopost 318. In list 308, there can be a string of less than 27 characters to limit the amount of space taken in the user interface and permitting room for additional geoposts in list 308, a third party social network image next to a geopost 318; and a set of social sharing functions below geopost 318 (FIGS. 3D and 3E).

Geopost locations 309 can be displayed in perimeter 303 by any manner of location indicator, preferably a pin, dot, circle, filled circle, ellipse, rectangle, pixel, or any combination thereof If plurality of geoposts 318 are associated within a given area within area 305 or surrounding location 310, there can be a number indicating multiple geoposts or a sum total count of geoposts at such location 310. By way of non-limiting illustration, there can be a contrasting color, shape, or number, displayed upon, at, or adjacent to the given location associated with the location of multiple geoposts 310. FIG. 3C shows, by way of non-limiting illustration, a plurality of location of multiple geoposts 310 which can be a total number of geoposts 318 at or near location 310. Further, by way of non-limiting illustration, plurality of geoposts at location 310 can be within perimeter 303, and shown with map 50 within the area 305 that is searchable. Tapping, clicking, touching, pointing, or otherwise selecting a designated geolocation 307, 309, or 310 can display lost 308 with one or more geoposts 318 at location of interest 311.

Location of interest 311 can be a selected location pointed to by selecting a given location 309 or 310 having geopost 318 or a plurality of geoposts 318. Multiple geoposts 318 can be associated with location 311 and shown in list 308 can be from the third party social network, including geoposts 318 which can have map image 504.

Menu 316 can expand to provide additional options such as searching and posting, account settings, security options, navigation within the application, and the like.

Navigation icon 317 can display a directional indicator. Navigation can be provided from the user's last known GPS location to the selected location.

Geopost 318 can be a collection of information; by way of non-limiting illustration, geopost 318 can be generated by associating information 914. Geopost 318 can include, but is not limited to: message 502, perimeter 303, area 305, designated geolocation 307, and/or map image 504. One or more geoposts 318 can be displayed in list 308. Geopost 318 can have a string of less than 100 characters. In an embodiment, an image such as an icon or avatar can be displayed next to geopost 308 to indicate the user that posted geopost 318; and a set of social sharing functions below the geopost 318.

Searched keyword 322 can be any term, word, description, title, phrase, string, hashtag, username, subject, metadata, URL or portion thereof, domain name, identifier, or any combination thereof. A “value” can refer to a particular instance of a given parameter. By way of non-limiting illustration, a searched keyword 322 can be an instance of a given keyword parameter. Any number of parameter-value pairs can exist. Values can be input by users and sent in a request to the server. Server can be any number of servers, for example, in a cloud-based service having multiple physical or virtual servers.

Discovered keyword 324 can be any term, word, description, title, phrase, string, hashtag, username, subject, metadata, URL or portion thereof, domain name, identifier, or any combination thereof.

FIG. 3C is a user interface of an embodiment of the present invention.

Perimeter 303B is shown in FIG. 3C around designated geolocation 307 covering area 305 on map 50 with a plurality of geopost locations 309, multiple geoposts at respective locations 310 having a total count of geoposts associated with location 310. Search keyword input 322 can be provided in search bar 304 with search command 306 which can be indicated by an icon. Search command 306 can send keyword input 322, and designated geolocation 307 by selecting to activate the search command 306. Perimeter 303 can be included in the search request sent to the server. In a possible embodiment, a radius previously specified by area size value 350 (FIG. 3B) can be included with the search request to the server.

FIG. 3D is an embodiment of the present invention.

Map 50 is shown in FIG. 3D, with perimeter 303, search input field 304, search area 305, search command 306, designated geolocation 307, geosearch results 308 which can include further interactive UI icons and corresponding command elements, geopost location 309, location of multiple geoposts 310, menu 316, navigation icon 317, geopost 318, search keyword 322, and discovered keyword 324 shown in geopost 318 which can be in geopost search results 308.

FIG. 3E is a user interface of an embodiment of the present invention.

Map 50 is shown in FIG. 3E, with perimeter 303, search input field 304, search area 305, search command 306, designated geolocation 307, geosearch results 308 which can include further interactive UI icons and corresponding command elements, third-party or preexisting geopost location 309, location of multiple geoposts 310, menu 316, navigation icon 317, geopost 318, search keyword 322, and discovered keyword 324 shown in geopost 318 which can be in geosearch results 308.

FIG. 4 is a user interface of an embodiment of the present invention.

Contrasting layer 400 is shown in FIG. 4, with action menu 450, designate geosearch location option 452, designate geopost location option 454, map 50 and search command 306.

Contrasting layer 400 can be a dimmed, darkened, contrasting color, or shaded portion of the user interface which can display action menu 450, option menu 316, or both. By way of non-limiting illustration, search input field 304 can preferably be brighter in contrast to layer 400, thereby indicating usability.

Action menu 450 can include a prompt. In a preferred embodiment, menu 450 can preferably include two options: designate geosearch location option 452 and designate geopost location option 454. By way of non-limiting illustration, provide simple options in a dialog box: change search location or post here. FIG. 4 shows how the present invention can be adapted to a social network such as Twitter, to permit the end user to understand the type of post to be made and if limited then to which network the posting will be made. The term used to post to a given social network can be dynamically assignable by programming the proper string to appear as a menu option in the present menu 450. In some embodiments, the action menu can be limited to two actions only; benefits thereof can be simplicity, ease of use, and a less-cluttered user interface. Showing map 50 primarily at the pre-designation

Designate geosearch location option 452 can initiate searching, execute searching, or to set search location 800. There can be a user interface icon, button, or otherwise selectable option in the user interface which can be activated to initiate changing where the search location is to be centered. Subsequently, by way of non-limiting illustration, the radius of perimeter 303 or area 305 can be designated.

Designate geopost location option 454 can be a menu option permitting the user to select to geopost at a specified location on map 50. Users can thereby set or adjust 902 location 307 of the given geopost 500 to be provided as a searchable geopost 318, later to be discoverable by other users via search term 322 within the later-specified area 305.

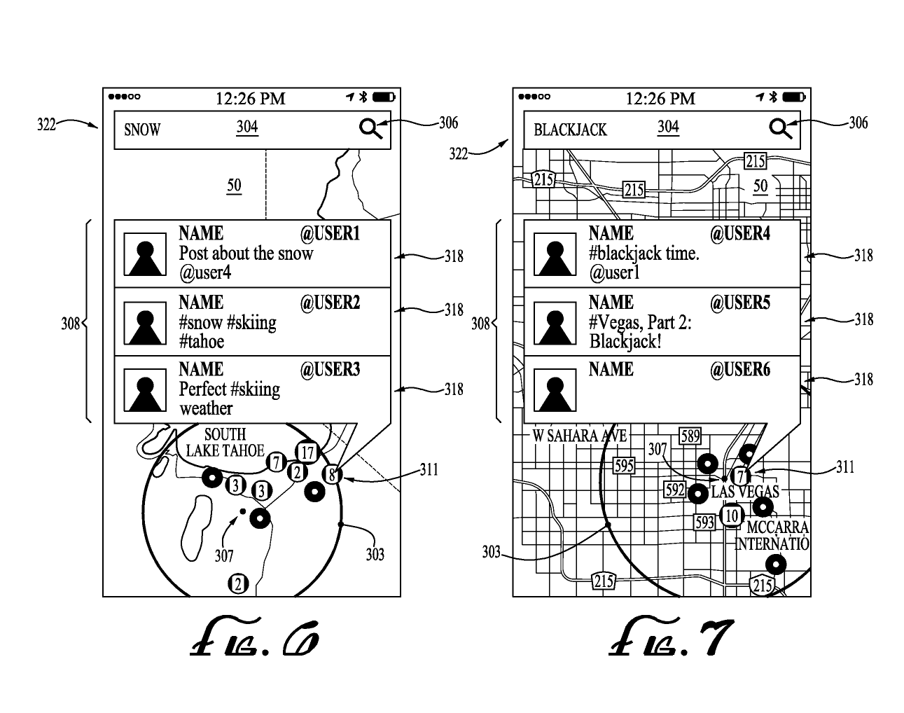

FIG. 5 is a user interface of an embodiment of the present invention.

Geopost 500 is shown in FIG. 5, with map 50 shown with keyboard input, message 502, map image 504, social network identifier 506, cancel 508, post 510, message character count 512, search command 304, and contrasting layer 400.

Message 502 can be any communicated digital expression, by way of non-limiting illustration: text, hashtag, username, or any combination thereof

Map image 504 can be an image of the map view without any input fields. Map image 504 can be a thumbnail of such map image displayed within the contrasting area of the geopost 500 input dialog in the user interface.

Social network identifier 506 can be any hosted service on any website, including any social network, blog, communication platform, group messaging, or any combination thereof By way of non-limiting illustration, social network 506 can be any social network, blog, or website, or any combination thereof. Social network identifier 506 can be text, image, or a combination thereof—any description of the social network to which the pending geopost will be communicated. Social network identifier 506 can distinguish publishing on other social networks. The present invention can be configured to publish on multiple social networks simultaneously and is not necessarily limited to a single network. In a possible embodiment, however, social network 506 can be limited thereby to enhance the value of the social network functionality. A benefit of the social network identifier is that the present invention need not create its own social network and can be integrated with any preexisting social network, yet can also provide enhanced functionality for text-based social networks lacking the easily-accessible functions of geopost and geosearch described in this specification. When a user signs up with the application of the present invention, the functionality can optionally provide the user with the ability to authenticate using the preexisting authentication of a social network, by way of non-limiting illustration, 43 Things, Academia.edu, About.me, Advogato, allobii, AsianAvenue, aSmallWorld, Athlinks, Audimated.com, Bebo, Biip.no, BlackPlanet, Blauk, Blogster, Bolt.com, Busuu, Biizznet, CafeMom, Caret, CaringBridge, Classmates.com, Cloob, CouchSurfing, CozyCot, Cross.tv, Crunchyroll, Cyworld, DailyBooth, DailyStrength, delicious, deviantART, Diaspora, didlr, Disaboom, Dol2day, DontStayln, Draugiem.lv, douban, DXY.cn, Elftown, Elixio, English, baby!, Epernicus, Eons.com, eToro, Experience Project, Exploroo, Facebook, Faceparty, Faces.com, Fetlife, FilmAffinity, Filmow, FledgeWing, Flixster, Flickr, Focus.com, Formspring, Fotki, Fotolog, Foursquare, Friendica, Friends Reunited, Friendster, Friihstiickstreff, Fuelmyblog, FullCircle, Gaia Online, GamerDNA, Gapyear.com, Gather.com, Gays.com, Geni.com, GetGlue, Gogoyoko, Goodreads, Goodwizz, Google+, GovLoop, Grono.net, Habbo, hi5, Hospitality Club, Hotlist, HR.com, Hub Culture, Hyves, Ibibo, Identi.ca, Indaba Music, Instagram, IRC-Galleria, italki.com, Itsmy, iWiW, Jaiku, Jiep ng, Kaixin001, Kiwibox, Lafango, LaiBhaari, Last.fm, LibraryThing, Lifeknot, LinkedIn, LinkExpats, Listography, LiveJournal, Livemocha, Makeoutclub, MEETin, Meetup, Meettheboss, MillatFacebook, mixi, MocoSpace, MOG, MouthShut.com, Mubi, MyHeritage, MyLife, My Opera, Myspace, Nasza-klasa.pl, Netlog, Nexopia, NGO Post, Ning, Odnoklassniki, Open Diary, Orkut, OUTeverywhere, PatientsLikeMe, Partyflock, Pingsta, Pinterest, Plaxo, Playfire, Playlist.com, Plurk, Poolwo, Qapacity, Quechup, Qzone, Raptr, Ravelry, Renren, ReverbNation.com, Ryze, ScienceStage, Sgrouples, ShareTheMusic, Shelfari, Sina Weibo, Skoob, Skyrock, SocialVibe, Sonico.com, SoundCloud, Spaces, Stage 32, Stickam, StudiVZ, Students Circle Network, StumbleUpon, Tagged, Talkbiznow, Taltopia, Taringa!, TeachStreet, TermWiki, The Sphere, TravBuddy.com, Travellerspoint, tribe.net, Trombi.com, Tuenti, Tumblr, Twitter, Tylted, Vkontakte, Vampirefreaks.com, Viadeo, Virb, Vox, Wattpad, WAYN, WeeWorld, We Heart It, Wellwer, WeOurFamily, Wepolls.com, Wer-kennt-wen, weRead, Wiser.org, Wooxie, WriteAPrisoner.com, Xanga, XING, Xt3, Yammer, Yelp, Zoo.gr, Zooppa, any other social network, blog, or website, or any combination thereof

Cancel 508 can be a command selectable in the user interface to close the dialog to create the geopost 500. In a possible embodiment, the user interface can return the user to initiate geosearching 800-810, with the option of designating a new location 307.

Post 510 can be a command selectable in the user interface that initiates communication of the geopost 318 to the social network identified by the social network identifier 506.

Character count 512 can be the number of characters remaining to be posted or the number of characters that the post has accumulated, preferably including spaces.

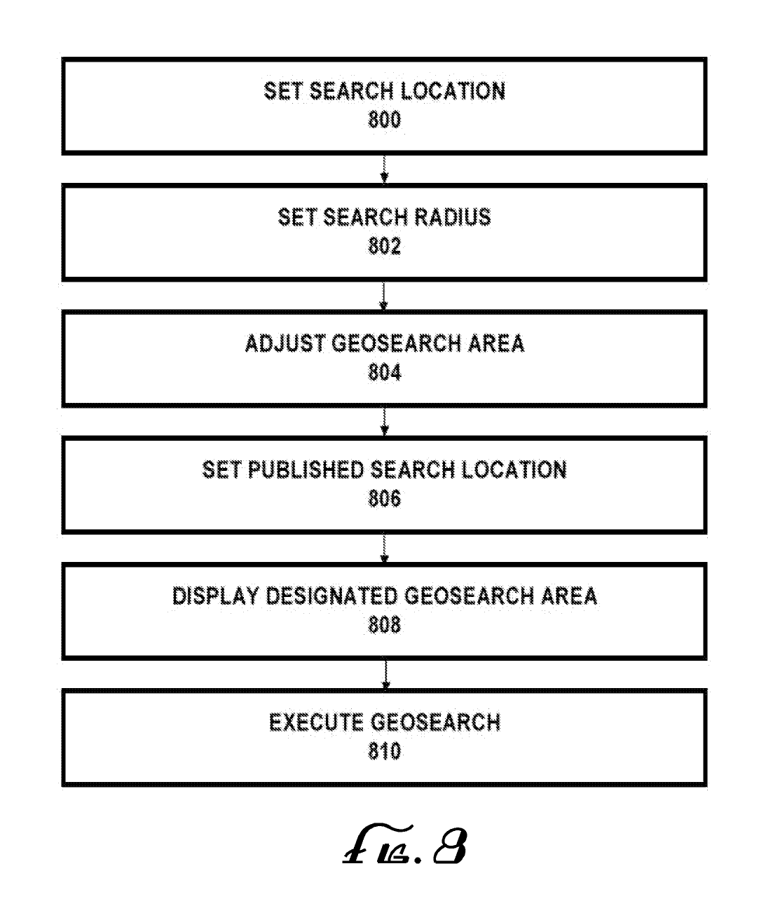

FIG. 6 is a user interface of an embodiment of the present invention.

Map 50 is shown in FIG. 6 with designated geolocation 307, perimeter 303, search input field 304, search command 306, search keyword 322, plurality of geoposts 308, geoposts 318, location of interest 311. By way of non-limiting illustration, a user can search for “snow” as a possible search term 322 in the geosearch results 308 which can be a plurality of geoposts within the specified area circumscribed by perimeter 303. A subset of multiple geoposts 308 can be displayed in the user interface for a selected nearby location of interest 311. In this example, the user finds references to snow in the South Lake Tahoe area and is then able to post, search further via 304, query by hashtag, or user. Displayed geoposts 308 can be scrollable in the user interface to accommodate longer listings of past geoposts, preferably in reverse-chronological order.

FIG. 7 is a user interface of an embodiment of the present invention.

Map 50 is shown in FIG. 7 with designated geolocation 307, perimeter 303, search input field 304, search command 306, search keyword 322, plurality of geoposts 308, geoposts 318, location of interest 311. By way of non-limiting illustration, other users in the Las Vegas area may post a blackjack-related geopost, later searched and discoverable by a user within the search area provided by perimeter 303.

FIG. 8 is a method of an embodiment of the present invention. Set search location 800 is shown in FIG. 8, with set search radius 802, adjust geosearch area 804, set published search location 806, display designated geosearch area 808, and execute geosearch 810. The method disclosed in FIG. 8 can be controllable by the software application on the mobile device installed on the operating system or accessible through a web browser on a mobile client device.

Set search location 800 can be performed by selecting a point on a map by controlling a mobile device client. By way of non limiting illustration, setting search location 800 can be performed by tapping a touchscreen of mobile device to thereby input a coordinate on map 50, zooming in to locate where the current desired location can be prior to selecting a particular point, zooming out prior to selecting a particular point on map 50. Geopost 318 can be authorized to be published publicly or privately on social network corresponding to social network identifier 506. By way of non-limiting illustration, authentication inputs can be selected from: username, password, IP address, cookie, session ID, client ID, or any combination thereof, encrypted or non-encrypted. Providing a prebuilt application protocol can send authentication inputs to a selected or integrated third party social network hosted elsewhere, not running on the server, initially receiving inputs from the mobile client device. Authorizing a third party social network with a posting permission, where the posting is both shared and sharable. The mobile app can be stored on a non-transitory computer-readable medium.

Set search radius 802 can be performed by adjusting the current map view to center upon a specific map point or area. Set search radius 802 can be done automatically by default surrounding a given designated geolocation 307, or by adjusting perimeter 804.

Adjust geosearch area 804 can be performed by select-and-drag of perimeter 303, area 305, or slider 300 any change, enlargement or reduction in size of perimeter 303. Adjust geosearch area 804 can be performed by manipulating the user interface control application on the mobile client device to set the area searched for geoposts. By way of non-limiting illustration, adjust perimeter 804 can be performed by moving slider 300 to increase or decrease zoom perspective view of map 50, clicking plus to zoom in or minus to zoom out affecting the map 50 view, tapping a scale thereof for perspective zooming, or using two-finger view modification in the map 50. Adjust geosearch area 804 can be modify area 305 via control of the mobile device, to change either the search area when using perimeter 303 to search, or the posting area when using perimeter 303 when geoposting. The present invention can transform the combination of search input 322 and designated geolocation 307 to provide area 305 as a search area, or to provide search results of one or more geopost locations 309 or 310 within the searched area 305. Thus, an aspect of the present invention can be to modify what is searched at the same time the area the user desires to view is selected dynamically.

Set published search location 806 can correspond to a user's mobile device GPS location. In an embodiment, set published search location 806 can include setting a GPS location where an input from the user's mobile device client, via control of a software application installed on the mobile device, can send to a server to specify where the search location can be designated. The request to set published search location 806 can be sent from the mobile application to the server. This can occur, by way of non-limiting illustration, when the search location is set 806 can occur via HTTP, secure HTTP, FTP, secure FTP, or any proprietary protocol over TCP/IP, UDP, or any other protocol now known or later developed, or any combination thereof.

Display designated geosearch area 808 can be performed by displaying onto a portion of map 50 an area 305 to be searched. By way of non-limiting illustration, Display designated geosearch area 808 can be performed by displaying by a continuous line drawing perimeter 303 or by a different shade of color indicated area 305.

Execute geosearch 810 can be performed by submitting the request to the server and receiving the response, then displaying the response on screen in the user interface with results shown within the previously designated search area sent in the search request. Execute geosearch 810 need not require a further action of selecting and submitting a search command. Execute search 810 can occur by the completion of at least two steps: designating geosearch area 305 and providing search terms 322 regardless of which is performed first.

FIG. 9 is a publishing method of an embodiment of the present invention.

A method for preparing a shareable social map can be performed by the following steps: display user interface 900; initiate post location 902; adjust geopost area 908; display adjusted geopost area 908; initiate geopublish command 910; auto-generate associated map image without further user input 912; auto-associate information 914, by way of non-limiting illustration including: location, map image, text, hashtag, username, social network identity, and authentication credentials; communicate geopost to social network without further user input 916; and display geopost confirmation 918. By way of non-limiting illustration, the method for preparing the shareable social map can involve no manual input of a GPS coordinate nor a radius numeric value to effect publication when the geopost command is activated. Map 50 can be displayed on a mobile software application via a GPS location capable of being authenticated by at least two authentication credentials, providing a prebuilt application protocol which sends the authentication credentials to the third party social network, authorizing a third party social network with a posting permission, where a resulting geopost 318 can be shared. A method for preparing a shareable social map can by performed by displaying a user interface on a mobile client device, providing an input to a user interface both text information and a location, sharing a geopost on a social network, and storing the sharing application on a non-transitory computer-readable medium. Social network can be any existing, co-hosted, or separately-hosted third party social network or a social network that is controlled or hosted by the same services or cloud wherein the server-side programs may operate. It is possible to integrate the present invention to a social network.

Display user interface 900 can be performed by initiating display of map 50 on a mobile client device. Controlling the client application installed on the mobile device can be performed by preparing geopost 318 through steps 900-918.

Set geopost location 902 can be performed by selectively pointing, touching, tapping, clicking, or otherwise indicating in the user interface any particular location on map 50 to position designated geolocation 307. A benefit of the step of setting geopost location 902 can be to facilitate geopost 318 being associated with location 902 without manual entry. Thereby, designated geolocation 307 can be established. designated geolocation 307 can be associated with the text of a post and the map image based on designated geolocation 307 as designated 902 for the pending geopost. A benefit of setting geopost location 902 can be to provide a basis to form map image 504 or a thumbnail thereof to be included in the geopost to one or more third party social networks. Upon setting geopost location 902, there can be a semitransparent circle in the map interface around the GPS location superimposed on map 50. A geopost location is distinct from a geolocation since a geolocation has no post data associated therewith. There can be a message pending social sharing on the mobile client, on the server, or both, which can remain unassociated with the perimeter 303, area 305, or designated geolocation 307 until the step of associating information 914. In a possible embodiment, a user can geopost a GPS location via the mobile client sharing application while not providing one's GPS coordinates to the third party social network provider.

Adjust geopost area 908 can be any change, enlargement or reduction in size of perimeter 303. Adjust geopost area 908 can be performed by manipulating the user interface control application on the mobile client device to set the area by which a pending geopost may be discovered by others when conducting a subsequent geosearch. Adjust geopost area 908 can be performed after selecting the option to change in the designated geopost location 454.

Input message 910 can be performed by input via a form field capable of accepting text, hashtag, or any group of characters, special or non-special, including but not limited to: ANSI, ASCII, UTF-8, UTF-16, UTF-32, XML, HTML, doublebyte, multibyte, including but not limited to hashtags, URLs, and linked usernames, linked hashtags. The user interface can provide an input field for content to be provided in geopost 500.

Auto-generate associated map image 912 can be performed by using the user's map view prior to activating the post option and creating an image with or without perimeter 303, with or without designated geolocation 307, with or without geopost 500. Auto-generating associated map image 912 without requiring any manual user input. By way of non-limiting illustration, initiate geopublish command 910 can include associating 914 information.

Associate information 914 can by performed, by way of non-limiting illustration, by associating any of the following: designated geolocation 307, map image 504, message 502, and social network identifier 506. Social network corresponding to social network identifier 506 can be operated by the same person or entity controlling the server that receives requests from the mobile devices sending requests to search or post. Posting and searching can be separated on different physical servers to provide precompiled executions running one or more instances in memory with a queue from any number of mobile device clients that have prepared geosocial posts via 900. Prebuilt database queries, structured or unstructured, and data access objects can perform retrieval and the response from a server to a publishing request can be returned to the mobile client device application. The mobile client device application with map 50 can then display a new post that can be searchable by others as a geopost location 309 or multiple geoposts location 310 included with other posts at or near the same location where the original designated geolocation 307 of the geopost 318 was made. In a preferred embodiment, associating 914 can be performed by keeping geopost information in a browser session as actions are stepwise accumulating more input, by way of non-limiting illustration: designating location and inputting message, for example. Another possible embodiment can pass information via http querystring of stored values in the browser of the client on the mobile device. In a possible embodiment, associating 914 can be performed by keeping session information on the server or cloud.

Communicate geopost 916 can be performed by sending a request to post information to a third party social network. Communicate geopost 916 can be performed without requiring further user input. Communicate geopost 918 can include providing an input to a user interface both text information and a selected location or default location. Further, prepare geosocial post 900 can also include providing a radius, map image 50, and text input simultaneously by the activation of a user interface command (FIGS. 4 and 5). By way of non-limiting illustration, the following can be used to prepare content to be included in geopost 318: map 50, geopost 500, message 502, map image 504, social network identifier 506, or any combination thereof. Communicate geopost 918 can be performed by sending a request, the request having publishing information, including geoposting information, to be sent to a server. Communicate geopost 918 can include simultaneous input of text, image, and location requested to a server via any communication protocol controlled by the mobile computing device upon which application software can be installed and operating. By way of non-limiting illustration, metadata can be associated with the performance of communicating geopost 916 to provide structured or unstructured information or data.

By way of non-limiting illustration, communicating geopost 916 can include: inputting message 910, generating map 912, associating information 914, and communicating to a third party social network 916. By way of non-limiting illustration, post 510 (FIG. 5) can be automatically cause to be performed any combination of, or all of steps 912, 914, 916, and 918 by programmatic flow of operation. One having an ordinary level of skill in the pertinent art would know how to program the flow of operation based on the present specification as disclosed. Using the various inputs pertaining to geopost 500, including but not limited to: designated geolocation 307, map 50, map image 504, and social network identifier 516. In an embodiment, communicating geopost 916 can be initiated by inputting message 910 and activating a command to post 510. A benefit of publishing without further manual input can be to streamline the publishing process by automatically creating an image without upload, photo selection from prior photos, or the like. A further benefit of communicating geopost 916 can be to make publishing geoposts easy to use and subsequently easy to discover by others in association with a given social network. There can be a map interface providing a desired geopost location by selecting a point on the map, wherein the act of selecting the map immediately refreshes the map screen centered on the selected location on the map and simultaneously displays a text input field and a posting command option, wherein the post command option results in no further action required by the user to share the current location along with the updated semitransparent circle, the post text, a hashtag, on the third party social network.

Display geopost 918 can be performed by updating by push or pull, preferably a response from server to client mobile device, whether browser-based in a web application or a natively-installed application on the client's mobile device, thereby updating the user interface to show that the post has been sent, updated, communicated, submitted to social network 506, or otherwise published.

Other embodiments in accordance with the present invention may be employed as is known to those skilled in the art of social media publishing.

A person having an ordinary level of skill in the pertinent art can determine, without undue experimentation, the appropriate variables, configurations, application programming interfaces, and other features of the claimed invention. Similarly, a person having an ordinary level of skill in the pertinent art can determine, without undue experimentation, the appropriate user interfaces, integrations to third party systems, and other features of the present invention.

While particular forms of the invention have been illustrated and described with regard to certain embodiments of the present invention, it will also be apparent to a person having an ordinary level of skill in the pertinent art that various modifications can be made without departing from the scope of the invention.

While certain aspects of the invention have been illustrated and described herein in terms of its use with various specific third party social networks and mobile computing devices, it will be apparent to those skilled in the art that the present invention can be programmed from many languages or made to work with many third party systems, including social networks or mobile operating systems or third party programming platforms or packages, not specifically discussed herein. Further, particular layouts and user interfaces of the present invention have been described herein and are provided as examples only. Other modifications and improvements may be made without departing from the scope of the invention. Accordingly, it is not intended that the invention be limited beyond the intended scope of the invention, for example, but not limited to, the appended claims.

What is claimed is:

1. A method for preparing a geopost, comprising:
preparing, by a client application, a geopost; and
sharing the geopost on a social network, wherein the geopost is stored on a server, the server having a non-transitory computer-readable storage medium.

2. the method of claim 1, further comprising: setting a designated location of the geopost and inputting a message.

3. the method of claim 2, further comprising: automatically generating a map image based on the designated location.

4. the method of claim 3, further comprising: designating the location by selectively pointing, touching, tapping, clicking, or otherwise indicating in a user interface any particular location on the map image to position the designated location.

5. the method of claim 2, further comprising: receiving an input via a form field wherein the designated location is communicated to a third party social network without further user input and simultaneously setting the designated location to be the designated location of the geopost.

6. the method of claim 3, further comprising: automatically associating an at least two selected from: the designated location, the map image, a text, a hashtag, and a username, to create a geopost, wherein the text comprises the message; wherein automatically associating is performed without further user input.

7. the method of claim 3, further comprising: communicating the geopost by sending a request to be sent to a third party social network without further user input to initiate the request to be sent from the server to a third party social network server.

8. the method of claim 7, wherein no manual numeric input of a GPS coordinate nor a numeric value is required during creation of the geopost.

9. A method for searching a geotagged map in a social network, comprising:
controlling a geolocation keyword search via a searching application capable of searching prior geoposts on a social network, wherein the searching application comprises: a map displayed on a mobile software application via a location;
searching with an at least one geopost and a designated geolocation; and
wherein the searching application is stored on a non-transitory computer-readable medium.

10. An apparatus for posting remarks on a geotagged map, comprising: a map controllable via a client application; whereby a geosearch is capable of being executed via the client application; and whereby a geopost area on the map is shown via use of the client application.

11. the apparatus of claim 10, further comprising: a numeric indicator of prior geoposts at the geopost area displayed on the map, wherein the numeric indicator represents a plurality of geoposts at the area shown on the map, and wherein the numeric indicator is in addition to a prior number of prior geoposts within the area.

12. the apparatus of claim 11, further comprising: the plurality of geoposts is displayed in a list corresponding to a designated location of interest.

13. the apparatus of claim 11, further comprising: the plurality of geoposts comprises an at least two geoposts.

14. the apparatus of claim 11, wherein the geopost further comprises the area, the location of interest, and where a map location is used to automatically generate a map thumbnail image showing the map location, the area, and the designated location of interest without further selection;

15. the apparatus of claim 11, wherein a further location of interest comprises a selected location pointed to by selecting the geopost from the list corresponding to the designated location of interest.

16. the apparatus of claim 13, wherein the at least two geoposts each individually correspond to the designated location of interest.

17. the apparatus of claim 16, further comprising: a slider configured to selectively change the size of the geopost area, wherein the radius is dynamically refreshed during selection to indicate a distance in units of measure.

18. the apparatus of claim 17, further comprising: a slider controls the size of the search area, wherein the radius is dynamically refreshed during selection to indicate a distance in units of measure inherent to the radius corresponding to the search area as modified via the slider.

19. the apparatus of claim 16, wherein no selection of a third party social network is required the geopost is created; and where the geopost is communicated to and posted on the third party social network upon posting the geopost via the client application.

20. the apparatus of claim 19, wherein the map thumbnail image is included in the geopost prior to sending the request to the third party social network.
